(19) United States
(12) Patent Application Publication
(10) Pub. No.: US 2002/0038929 A1
(43) Pub. Date: Apr. 4, 2002

(54) Shock absorber

(76) Inventor: Leo Martin Now, South San Francisco, CA (US)

Correspondence Address: SAMUEL W. APICELLI, DUANE, MORRIS & HECKSCHER LLP, 305 NORTH FRONT STREET, P.O. BOX 1003, HARRISBURG, PA, 17108-1003, US

(21) Appl. No.: 09/948,838

(22) Filed: Sep. 7, 2001

Related U.S. Application Data
(63) Continuation-in-part of application No. 29/125,564, filed on Jun. 23, 2000, now abandoned.

(51) Int. Cl. F16F 9/00

(52) U.S. Cl. 267/217

(57) ABSTRACT

The present invention provides a modified shock absorber, which comprises a shock damping tube, an upper spring seat, a lower spring seat, a fixing ring, a resilient part, and a bearing seat. The resilient part comprises two springs of different spring constants. The bearing seat is used to connect the two springs up and down in series. Because the spring of larger spring constant restores to its original state more easily, and the spring of smaller spring constant absorbs energy more easily, higher effect of stability can be provided when they are connected in series. In other words, two springs of different spring constants connected in series are exploited to absorb energy in two steps so that a car will not easily skid and will have better stability when making a turn.

### CROSS REFERENCE TO RELATED APPLICATIONS

This application is a continuation-in-part of U.S. application Ser. No. 29/125,564 filed Jun. 23, 2000, from which application applicant claims priority.

### FIELD OF THE INVENTION

The present invention relates to a shock absorber, and more particularly to a shock absorber capable of providing enhanced flexibility and energy absorbing capability, wherein two springs having different spring constants are connected in series so as to absorb energy in two steps thus improving anti-skid performance and turning stability in a vehicle.

### BACKGROUND OF THE INVENTION

Prior art shock absorbers of the type used in vehicles, such as automobiles, typically include a shock damper and a spiral spring. The shock absorbing capability of the shock damper often depends upon the spring constant of the spiral spring. Factors considered when designing shock dampers include the weight of the vehicle and the probable range of driving speeds. The shock absorbing capability of a shock damper and the spring constant of a spiral spring are often determined before leaving the factory. However, selection process for the shock absorbing capability of the shock damper and the spring constant of the spiral spring cannot fully anticipate all of the requirements of future drivers. Additionally, because the height of cars is standardized, the spiral spring will need to have a certain length. It is known that the larger the spring constant of a spring, the more easily the spring restores to its original state after a deflection. A spring having a smaller spring constant absorbs energy more easily. Much effort has been devoted to researching spring constants for spiral springs of the type used in prior art shock absorbers, in an attempt to achieve higher stability and comfort when an automobile is driven over uneven roads, at high speeds, or steered.

As shown in FIG. 1, a prior art shock absorber for a car includes a shock damping tube 1a, a spring 2a, an upper spring seat 3a, and a lower spring seat 4a. Shock damping tube 1 a often includes a full-stroke threaded tube body 1a having a sufficient length, and a spindle 11a sleeved into shock damping tube 1a and protruding out of the top face thereof. Spring 2a has a standard length, and is sleeved on shock damping tube 1a and the outer surface of spindle 11a. Spring 2a is located between upper spring seat 3a and lower spring seat 4a. Upper spring seat 3a, at the top end of spindle 11a, is connected to a frame girdle (not shown) of the car. The bottom end of shock damping tube 1a is connected to a connection seat (not shown) to join a wheel axle (not shown) of the car to the assembly.

As a consequence of this design, many prior art shock absorbers include a single spring 2a that is designed to have a certain spring constant that is often determined through the use of instruments and the like to suit the “average” road conditions assumed to be encountered during normal use, by an average driver. In actuality, different required spring constants will be necessary to provide optimum performance of the shock absorber on different roads.

### SUMMARY OF THE INVENTION

An object of the present invention is to provide a shock absorber which uses a two-section spring to provide enhanced anti-skid and turning performance in automobiles when traveling at high speeds.

To achieve this object, the present invention provides a shock absorber comprising a shock damping tube, an upper spring seat, a lower spring seat, a fixing ring, compound resilient means, and a bearing seat. In one embodiment of the invention, the compound resilient means comprise two springs of differing spring constant. The bearing seat is used to connect the two springs in series. Since the spring with the larger spring constant restores to its original state more readily after deflection, and the spring with the smaller spring constant absorbs energy more readily, an enhanced stability is provided when the two springs are connected in series relation to one another.

### BRIEF DESCRIPTION OF THE DRAWINGS

These and other features and advantages of the present invention will be more fully disclosed in, or rendered obvious by, the following detailed description of the preferred embodiment of the invention, which is to be considered together with the accompanying drawings wherein like numbers refer to like parts and further wherein:

FIG. 1 is a perspective view of a prior art shock absorber;

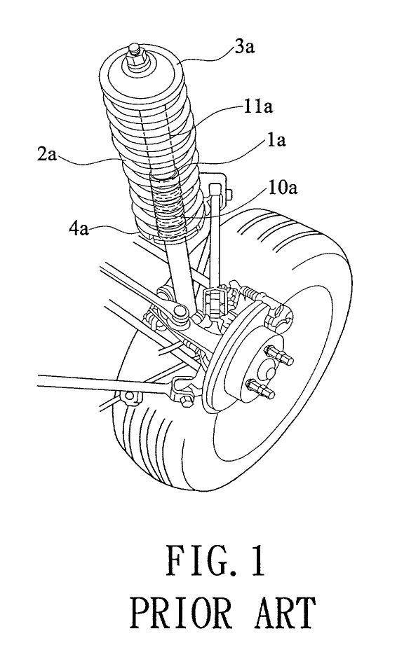

FIG. 2 is an exploded perspective view of a shock absorber formed in accordance with the present invention;

FIG. 3 is a cross-sectional view of a shock absorber formed in accordance with the present invention; and

FIGS. 4A and 4B are schematic illustrations representing the effect of external forces being applied to a two-section spring in a shock absorber formed in accordance with the present invention.

### DETAILED DESCRIPTION OF THE PREFERRED EMBODIMENTS

This description of preferred embodiments is intended to be read in connection with the accompanying drawings, which are to be considered part of the entire written description of this invention. In the description, relative terms such as “horizontal,” “vertical,” “up” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. In the claims, means-plus-function clauses are intended to cover the structures described, suggested, or rendered obvious by the written description or drawings for performing the recited function, including not only structural equivalents but also equivalent structures.

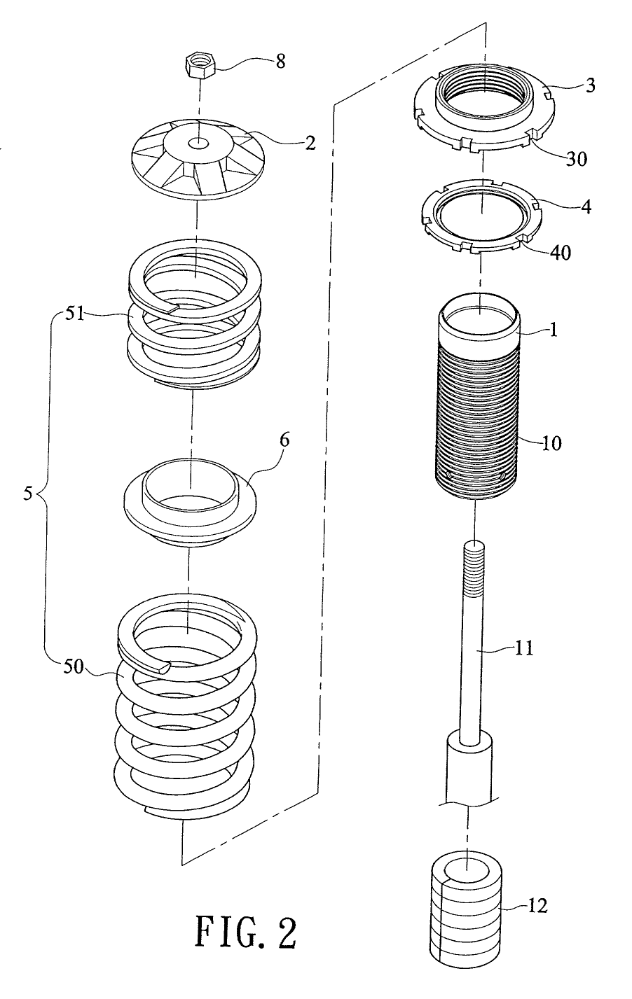

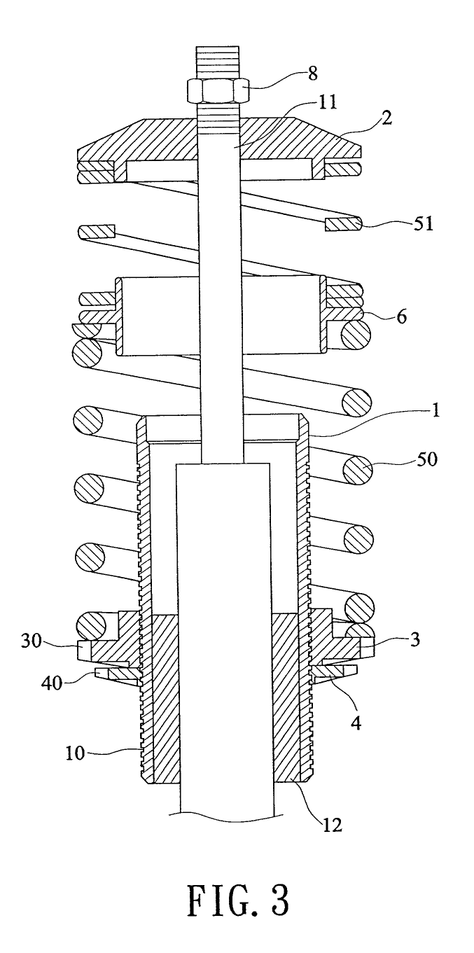

Referring to FIGS. 2 and 3, a shock absorber formed in accordance with the present invention comprises a shock damping tube 1, an upper spring seat 2, a lower spring seat 3, a fixing ring 4, compound resilient means 5, and a bearing seat 6. More particularly, shock damping tube 1 is a circular hollow tube having a plurality of threads formed on the periphery of a tube body 10. Lower spring seat 3 has inner threads to match the threaded portion of tube body 10 so as to be screwed onto shock damping tube 1. The outer edge of lower spring seat 3 includes a plurality of indentations 30, which are sized and shaped to be operatively engaged by a tool (e.g., a wrench, not shown) to adjust a pre-pressure applied to resilient means 5. The outer edge of fixing ring 4, at the lower end of spring seat 3, also includes a plurality of indentations 40, which are sized and shaped to be operatively engaged by a tool (e.g., a wrench, not shown) from the other direction so that lower spring seat 3 and fixing ring 4 may be located and tightly locked.

The inside of shock damping tube 1 includes a mobile rod 11 protruding out of and moving relative to shock damping tube 1, and a bushing 12 that mates with mobile rod 11. The other end of mobile rod 11 passes through upper spring seat 1 and is fixed by a cover plate seat (not shown) and a nut 8. Nut 8 also provides a block for maintaining compound resilient means 5 in place. In one embodiment of the invention, compound resilient means 5 comprise a pair of helical springs 50,51, which are sized so as to be disposed in substantially surrounding relation to the outer periphery of shock damping tube 1. An end of each of helical springs 50,51 abuts on upper spring seat 2 and lower spring seat 3, respectively. Compound resilient means 5 comprises two helical springs having different spring constants. Helical spring 50 provides a primary resilient portion due to its having a larger spring constant, and helical spring 51 provides a secondary resilient portion due to its having a relatively smaller spring constant. Bearing seat 6 connects helical springs 50,51 one-above-the-other, in series relation to one another. Each free end of primary spring 50 abuts between bearing seat 6 and lower spring seat 3, and each end of secondary spring 51 abuts between bearing seat 6 and upper spring seat 2.

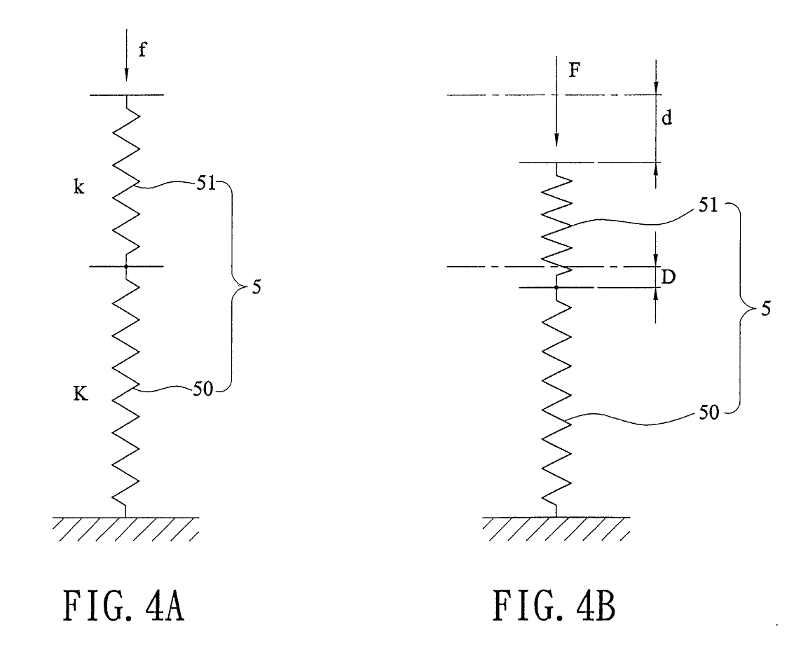

Referring to FIG. 4A, by adjusting lower spring seat 3 of and the weight of the car, a pre-pressure f can be generated. The spring constant of primary spring 50 is k. When helical springs 50,51 are compressed by an external force F, as shown in FIG. 4B, the compression flexibility of the primary spring 50 will be D, and the compression flexibility of the secondary spring 51 will be (d-D). Moreover, because k is large in magnitude, (d-D) will be larger in magnitude than D. When the wheel of the car accelerates up and down, as a result of the road conditions at the time, or when the car makes a turn, the car will experience a sudden external force or impulse. If this sudden external force or impulse is momentarily transferred to secondary spring 51, secondary spring 51 will absorb most of the impulse energy, with the remaining energy being transferred to primary spring 50. As a consequence, the amplitude of vibration of helical springs 50,51 will be reduced to an extent that the original state can be restored very quickly. Through the absorption of this impulse energy in two steps, passengers will experience a far more stable and comfortable ride.

The present invention provides a shock absorber for a car, wherein two springs of different spring constants are connected in series and exploited to absorb impulse energy in two steps so that a car will not easily skid and will have better stability when making a turn.

It is to be understood that the present invention is by no means limited only to the particular constructions herein disclosed and shown in the drawings, but also comprises any modifications or equivalents within the scope of the claims.

What is claimed is:

1. A shock absorber for a car, comprising:
a shock damping tube;
an upper spring seat and a lower spring seat positioned on said shock damping tube; and
compound resilient means surrounding the outer periphery of said shock damping tube abutting said upper spring seat and said lower spring seat.

2. The shock absorber according to claim 1 wherein the periphery of said shock damping tube has a plurality of threads, and said lower spring seat is threaded on to said shock damping tube.

3. The shock absorber according to claim 1 wherein the inside of said shock damping tube includes a mobile rod protruding out of and moving relative to said shock damping tube, and a bushing is provided to mate with said mobile rod.

4. The shock absorber according to claim 1 wherein the periphery of said shock damping tube has a fixing ring.

5. The shock absorber according to claim 1 wherein said compound resilient means comprises a primary spring having a relatively large spring constant and a secondary spring having a relatively small spring constant, with said primary spring abutting between said bearing seat and said lower spring seat, and said secondary spring abutting between said bearing seat and said upper spring seat.

6. A shock absorber:
a shock damping tube;
an upper spring seat and a lower spring seat positioned on said shock damping tube; and
a first spring having a first spring constant and a second spring having a second spring constant, said first and second springs being coupled together in series by a bearing seat and arranged in surrounding relation to the outer periphery of said shock damping tube and abutting said upper spring seat and said lower spring seat.

7. The shock absorber according to claim 6 wherein the periphery of said shock damping tube has a plurality of threads, and said lower spring seat is threaded on to said shock damping tube.

8. The shock absorber according to claim 6 wherein the inside of said shock damping tube includes a mobile rod protruding out of and moving relative to said shock damping tube, and a bushing is provided to mate with said mobile rod.

9. The shock absorber according to claim 6 wherein the periphery of said shock damping tube has a fixing ring.

10. The shock absorber according to claim 6 wherein said first spring comprises a relatively large spring constant and said second spring comprises a relatively small spring constant, with said first spring abutting between said bearing seat and said lower spring seat, and said second spring abutting between said bearing seat and said upper spring seat.
